(19) United States
(12) Patent Application Publication
(10) Pub. No.: US 2016/0050627 A1
(43) Pub. Date: Feb. 18, 2016

(54) METHODS AND APPARATUS FOR POWER EFFICIENT ACCESS IN CONGESTED NETWORKS

(71) Applicant: QUALCOMM Incorporated, San Diego, CA (US)

(72) Inventors: Bhaskara Viswanadham Batchu, Medak (IN); Debesh Kumar Sahu, Hyderabad (IN); Venkata Siva Prasad Rao Gude, San Diego, CA (US); Jagadishwar Neela, Hyderbad (IN); Jun Hu, San Diego, CA (US); Rashid Ahmed Akbar Attar, San Diego, CA (US); Naveen Kumar Pasunooru, Hyderabad (IN)

(21) Appl. No.: 14/460,703

(22) Filed: Aug. 15, 2014

(51) Int. Cl. H04W 52/02; H04W 76/04

(52) U.S. Cl. CPC H04W 52/0235; H04W 76/048

(57) ABSTRACT

Methods and apparatus for of tracking network system timing are provided. In one aspect, a method for wireless communication comprises determining a probability of passing an accessibility test for accessing a network. The method further includes comparing the determined probability to a threshold. The method further includes selectively performing a backoff procedure for a period of time based on the comparison.

### BACKGROUND

1. Field

Certain aspects of the present disclosure generally relate to wireless communication systems, and more particularly, to methods and apparatus for power efficient access in congested networks.

2. Background

In many telecommunication systems, communications networks are used to exchange messages among several interacting spatially-separated devices. Networks can be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), a neighborhood aware network (NAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g., Internet protocol suite, SONET (Synchronous Optical Networking), Ethernet, etc.).

Certain devices operating in a network may not need to frequently connect with the network to deliver or receive data. Accordingly, the network or a base station (BS) may assign a long discontinuous reception (DRX) cycles or sleep lengths or slot cycle index (SCI). However, long DRX/SCI cycles may result in devices losing network timing information. Accordingly, there is a need for devices to track system timing information when operating in long DRX/SCI cycles.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method of wireless communication. The method includes determining a probability of passing an accessibility test for accessing a network. The method further includes comparing the determined probability to a threshold. The method further includes selectively performing a backoff procedure for a period of time based on the comparison.

Another aspect of the disclosure provides an apparatus for wireless communication. The apparatus includes a processor configured to determine a probability of passing an accessibility test for accessing a network, compare the determined probability to a threshold, and selectively perform a backoff procedure for a period of time based on the comparison.

Another aspect of the disclosure provides an apparatus for wireless communication. The apparatus includes means for determining a probability of passing an accessibility test for accessing a network. The apparatus further includes means for comparing the determined probability to a threshold. The apparatus further includes means for selectively performing a backoff procedure for a period of time based on the comparison.

Another aspect of the subject matter described in the disclosure provides a non-transitory computer-readable medium including code that, when executed, causes a processor to determine a probability of passing an accessibility test for accessing a network. The medium further includes code that, when executed, causes the processor to compare the determined probability to a threshold. The medium further includes code that, when executed, causes the processor to selectively perform a backoff procedure for a period of time based on the comparison.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 is a flow chart of an exemplary method for accessing a network.

FIG. 4 is a flow chart of another exemplary method for accessing a network.

FIG. 5A is an exemplary time sequence diagram of a wireless device attempting to access a network.

FIG. 5B is an exemplary time sequence diagram of a wireless device attempting to access a network by calculating a success probability of passing a persistence test

FIG. 6 is a flow chart of an exemplary method for wireless communication.

FIG. 7 is a functional block diagram of a wireless device that can be employed to perform a method of FIG. 6 in the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Wireless network technologies can include various types of wireless local area networks (WLANs). A WLAN can be used to interconnect nearby devices together, employing widely used networking protocols. However, the various aspects described herein can apply to any communication standard, such as a wireless protocol. The various aspects described herein can apply to any communication standard, such as the Institute of Electrical and Electronic Engineers (IEEE) 802.11 wireless protocols. For example, the various aspects described herein can be used as part of the IEEE 802.11a, 802.11b, 802.11g, 802.11n, and/or 802.11ah protocols. Implementations of the 802.11 protocols can be used for sensors, home automation, personal healthcare networks, surveillance networks, metering, smart grid networks, intra- and inter-vehicle communication, emergency coordination networks, cellular (e.g., 3G/4G) network offload, short- and/or long-range Internet access, machine-to-machine (M2M) communications, etc.

In some implementations, a WLAN includes various devices which are the components that access the wireless network. For example, there can be two types of devices: access points (“APs”) and clients (also referred to as stations, or “STAs”). In general, an AP can serve as a hub or base station for the WLAN and a STA serves as a user of the WLAN. For example, a STA can be a laptop computer, a personal digital assistant (PDA), a mobile phone, a wearable computing device (e.g., a watch), an appliance, a sensor, a vending machine, etc. In an example, a STA connects to an AP via a WiFi (e.g., IEEE 802.11 protocol) compliant wireless link to obtain general connectivity to the Internet or to other wide area networks. In some implementations a STA can also be used as an AP.

An access point (“AP”) can also include, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” can also include, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal can include a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device or wireless device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Wireless devices, such as a group of STAs, for example, can be used for neighborhood aware networking (NAN), or social-WiFi networking. For example, various stations within the network can communicate on a wireless device to wireless device (e.g., peer-to-peer communications) basis with one another regarding applications that each of the STAs supports. It is desirable for a discovery protocol used in a social-WiFi network to enable STAs to advertise themselves (e.g., by sending discovery packets) as well as discover services provided by other STAs (e.g., by sending paging or query packets), while ensuring secure communication and low power consumption. It should be noted that a discovery packet can also be referred to as a discovery message or a discovery frame. It should also be noted that a paging or query packet can also be referred to as a paging or query message or a paging or query frame.

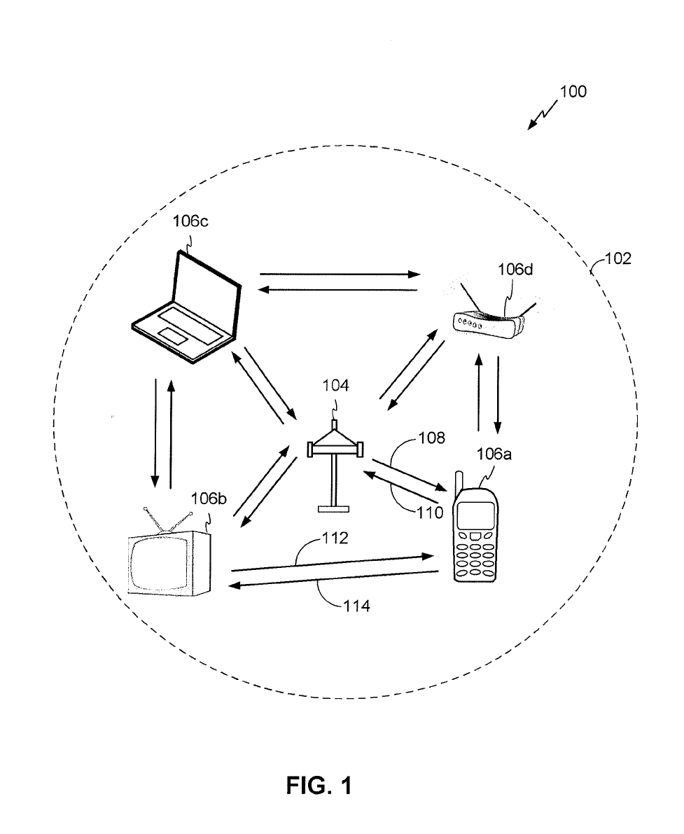

FIG. 1 illustrates an example of a wireless communication system 100 in which aspects of the present disclosure can be employed in accordance with an embodiment. The wireless communication system 100 can operate pursuant to a wireless standard, such as an 802.11 standard. The wireless communication system 100 can include an AP 104, which communicates with STAs 106. In some aspects, the wireless communication system 100 can include more than one AP. Additionally, the STAs 106 can communicate with other STAs 106. As an example, a first STA 106a can communicate with a second STA 106b. As another example, a first STA 106a can communicate with a third STA 106c although this communication link is not illustrated in FIG. 1.

A variety of processes and methods can be used for transmissions in the wireless communication system 100 between the AP 104 and the STAs 106 and between an individual STA, such as the first STA 106a, and another individual STA, such as the second STA 106b. For example, signals can be sent and received in accordance with OFDM/OFDMA techniques. If this is the case, the wireless communication system 100 can be referred to as an OFDM/OFDMA system. Alternatively, signals can be sent and received between the AP 104 and the STAs 106 and between an individual STA, such as the first STA 106a, and another individual STA, such as the second STA 106b, in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

A communication link can be established between STAs, such as during social-WiFi networking in a NAN. Some possible communication links between STAs are illustrated in FIG. 1. As an example, a communication link 112 can facilitate transmission from the first STA 106a to the second STA 106b. Another communication link 114 can facilitate transmission from the second STA 106b to the first STA 106a.

The AP 104 can act as a base station and provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather can function as a peer-to-peer network between the STAs 106. Accordingly, the functions of the AP 104 described herein can alternatively be performed by one or more of the STAs 106.

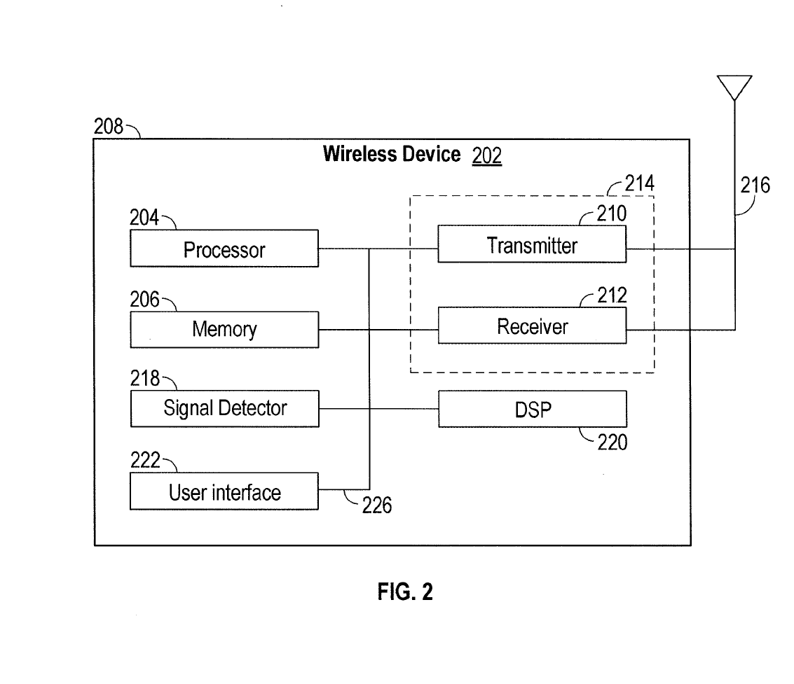

FIG. 2 illustrates various components that can be utilized in a wireless device 202 that can be employed within the wireless communication system 100 in accordance with an embodiment. The wireless device 202 is an example of a wireless device that can be configured to implement the various methods described herein. For example, the wireless device 202 can comprise the AP 104 or one of the STAs 106.

The wireless device 202 can include a processor 204 which controls operation of the wireless device 202. The processor 204 can also be referred to as a central processing unit (CPU). Memory 206, which can include both read-only memory (ROM) and random access memory (RAM), can provide instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and/or a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas.

The transmitter 210 can be configured to wirelessly transmit packets having different packet types or functions. For example, the transmitter 210 can be configured to transmit packets of different types generated by the processor 204. When the wireless device 202 is implemented or used as an AP 104 or STA 106, the processor 204 can be configured to process packets of a plurality of different packet types. For example, the processor 204 can be configured to determine the type of packet and to process the packet and/or fields of the packet accordingly. When the wireless device 202 is implemented or used as an AP 104, the processor 204 can also be configured to select and generate one of a plurality of packet types. For example, the processor 204 can be configured to generate a discovery packet comprising a discovery message and to determine what type of packet information to use in a particular instance.

The receiver 212 can be configured to wirelessly receive packets having different packet types. In some aspects, the receiver 212 can be configured to detect a type of a packet used and to process the packet accordingly.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a packet for transmission. In some aspects, the packet can comprise a physical layer data unit (PPDU).

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user. The wireless device can further comprise a battery (not shown) to power the wireless device.

The various components of the wireless device 202 can be coupled together by a bus system 226. The bus system 226 can include a data bus, for example, as well as a power bus, a control signal bus, and a status signal bus in addition to the data bus. The components of the wireless device 202 can be coupled together or accept or provide inputs to each other using some other mechanism.

Although a number of separate components are illustrated in FIG. 2, one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

Some mobile networks may be optimized for machine-to-machine (M2M) communications and may be less optimal for human-to-human communications. M2M devices may include wireless transmit/receive units, appliances (e.g., refrigerators, dishwashers, laundry machines, etc.), metering devices, vending machines, or the like that may access the network less frequently than devices used for human-to-human use. The M2M devices may be wireless sensors or the like that may be deployed to remote areas for monitoring tasks or other tasks, where there may be limited access to power. M2M devices may not be requested to listen to network signaling or network paging for long periods. In some cases, M2M device battery life may be expected to last for an extended period of time, such as a number of years.

Communication networks (e.g., Global System for Mobile communications (GSM) networks (NW), C2k, WCDMA) already have a high volume of traffic. With the addition of machine-to-machine (M2M) devices, it will further add load to these networks. M2M devices may send periodic reports. In densely populated area, when many M2M devices need to send periodic reports, they may perform access at same time leading to network congestion. In existing designs, M2M devices perform persistence (PSIST) test before making any system access. If the persistence test fails, user equipment (UE) doesn't send any message to network. However, the M2M device may remain in system access state and then perform persistence test again until the persistence test is passed. For these cases, if persistence test fails multiple times and M2M devices perform a large number of persistence checks in access state before it transmit any access message to the network, this would result in a large power consumption for actual data transmission.

Certain aspects of the present disclosure support allowing devices to determine a probability of passing a PSIST test before attempting to access a network. Whenever a M2M device wants to perform an access procedure, it can calculate persistent test success probability. If the success probability is less than a pre-defined threshold (TH) value then device may back-off for some time (t). After time t, the M2M device may try decoding an access persistence configuration value from network. If there is any change in access persistence configuration, it may then calculate a new PSIST test success probability. Timer ‘t’ can be customized or can be as per DRX. If the new success probability is greater than TH then the M2M device may then perform the PSIST test and perform access. If it the success probability still less than TH, the M2M device may continue to back-off access and this procedure can be repeated for some iterations (N) or until predefined timer (T) expired. Threshold value can be customized based on a trade off between UE power savings versus urgent access (e.g., a priority level for the UE or the data). Once the timer T expires, M2M device can execute a PSIST test and try for access. Timer T can be decided/customized per each carrier based on a maximum time in which carrier changes the PSIST value to a low value so that the UE can transmit data immediately. With this implementation, M2M devices may not spend as much time in access state and may transition back to idle mode if the PSIST success probability is less than TH. Hence, the UE will shut down Tx circuitry and save power. After moving to idle mode, the UE monitors the base station access persistence configuration, once there is a change in the PSIST value to a low value, it may perform access to the network.

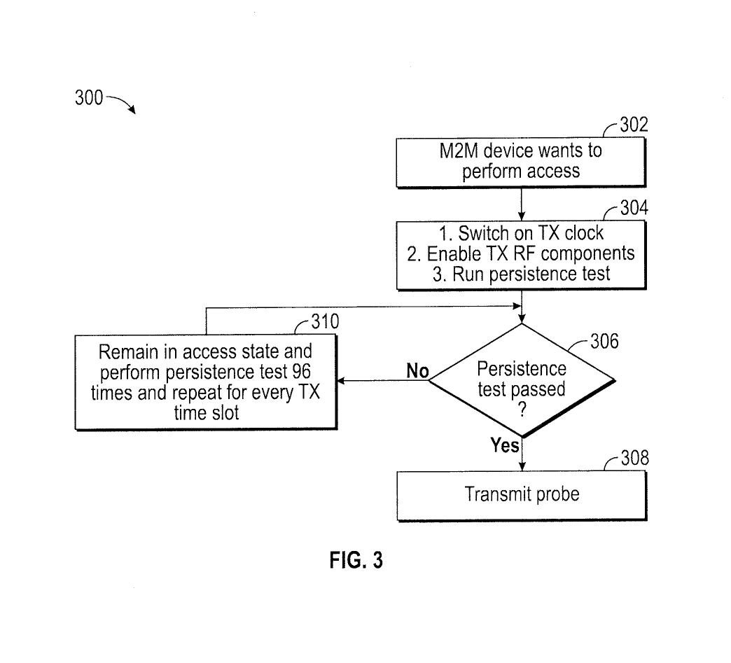

FIG. 3 is a flow chart of an exemplary method 300 for accessing a network. The method 300 may be implemented by the wireless device 202 and more specifically, the processor 204 or DSP 220. At block 302 the wireless device 202 determines it wants to access the network. At block 304, the wireless device 202 switches on its transmitter (TX) clock, enables its transmit radio frequency (RF) components, and runs a PSIST test. At block 306, the wireless device 202 checks whether the persistence test passed. If yes, the wireless device 202 transmits a probe as indicated in block 308. If no, at block 310, the wireless device 202 remains in the access state and repeats the PSIST test for every TX time slot. The wireless device 202 then returns to block 306 to determine if the PSIST test passed. If the PSIST test continually fails, the wireless device 202 may perform PSIST test a large number of times (e.g., 96 times) before the PSIST test passes.

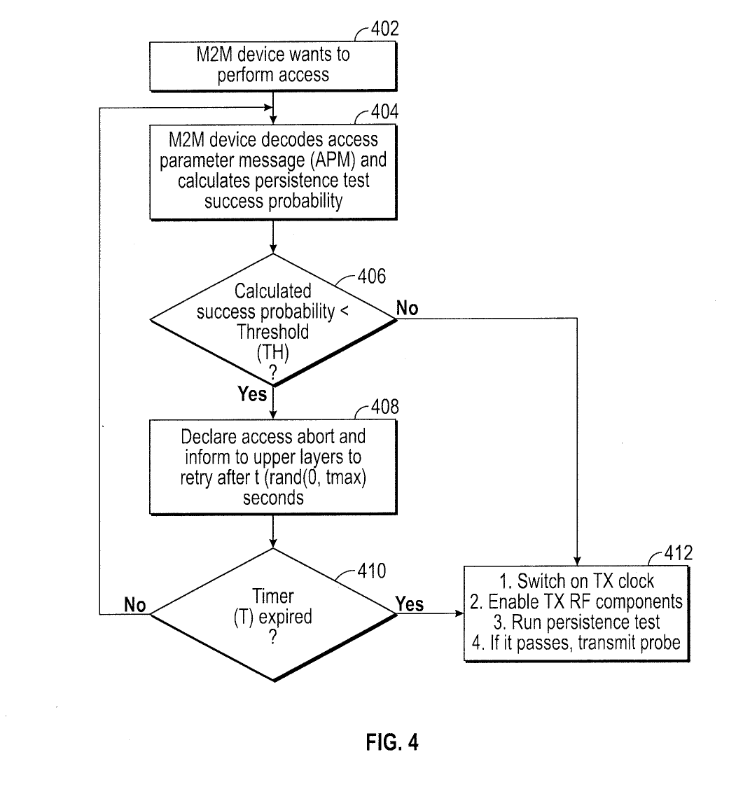

FIG. 4 is a flow chart of an exemplary method 400 for accessing a network. The method 400 may be implemented by the wireless device 202 and more specifically, the processor 204 or DSP 220. At block 402 the wireless device 202 determines it wants to access the network. At block 404, the wireless device 202 decodes an access parameter message (APM) or network configuration message to determine a network persistence value or a network configuration value. In some embodiments, the network persistence value or network configuration value may indicate a backoff period for the wireless device 202 to wait before performing a PSIST test. The wireless device 202 can then use the network persistence value or network configuration value to calculate the persistence test success probability. At block 406, the wireless device 202 checks whether the calculated success probability is less than a threshold (TH). In some embodiments, the value of the TH can be customized based on a trade-off determination between UE power savings versus urgent access. If the success probability is less than TH, the wireless device 202 aborts attempting to access the network and backs-off for a period of time. In some embodiments, the back-off period is the time t, described above. In some embodiments, the time t is a random number between 0 and maximum back-off period. The back-off procedure after the success probability is below the threshold may be repeated for a set number of iterations (N) or until a predefined timer (T) has expired. The timer, T, or the number of iterations, N, may be customized per each carrier based on a maximum time in which the carrier changes the PSIST value to a low value so that the UE can transmit data immediately. In block 410, the wireless device 202 checks whether the predefined timer T has expired or if the number of iterations has reached its maximum. If not, then the wireless device 202 returns to block 404 and determines whether the network persistence value or the network configuration value has changed and if so, calculates a new PSIST test probability. If the predefined timer T has expired, if the number of iterations has reached its maximum value, or if the success probability is greater than a threshold (TH), then in block 412, the wireless device 202 switches on its TX clock, enables its transmit RF components, runs a PSIST test, and transmits a probe if the PSIST passes.

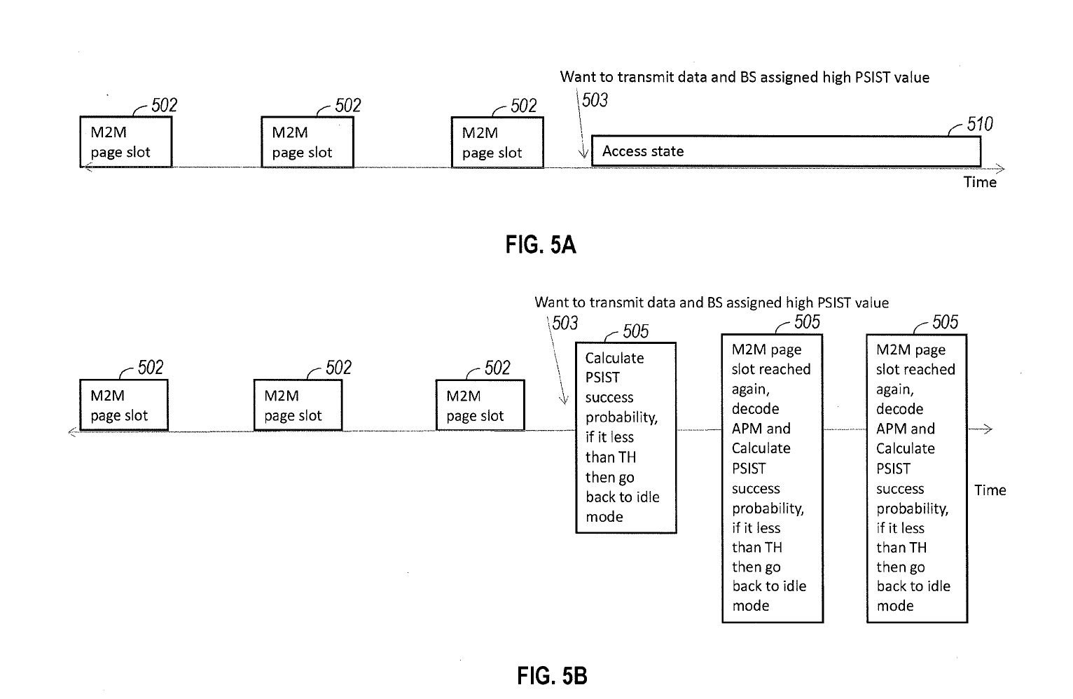

FIG. 5A is an exemplary time sequence diagram of a wireless device 202 attempting to access a network. In some embodiments the wireless device 202 comprises a machine-to-machine (M2M) device. In FIG. 5A, the wireless device 202, is assigned periodic page slots 502 and at time 503 the wireless device 202 determines it wants to transmit data. The wireless device 202 is assigned a high PSIST value and transitions to an access state 510 to run a PSIST test. The high PSIST value may cause the wireless device 202 to fail the PSIST tests multiple times and remain in access state 510 until the PSIST test passes.

FIG. 5B is an exemplary time sequence diagram of a wireless device 202 attempting to access a network by calculating a success probability of passing a PSIST test. In FIG. 5B the wireless device 202, is assigned periodic page slots 502 and at time 503 the wireless device 202 determines it wants to transmit data. The wireless device 202 is assigned a high PSIST value and then during times 505 calculates a PSIST success probability based on the PSIST value and if the success probability is less than a threshold, the wireless device 202 returns to an idle mode for a back-off period or until its next page slot. At each subsequent page slot time 505, the wireless device 202 decodes an APM or network configuration message to determine a PSIST value and calculates a PSIST success probability based on the PSIST value and if the success probability is less than the threshold, the wireless device 202 returns to an idle mode for a back-off period or until its next page slot. In the embodiment of FIG. 5B, the wireless device 202 may spend less time in the access state than the exemplary wireless device 202 depicted in FIG. 5A by returning to an idle mode between page slots. If during the any of the times 505 the success probability is greater than the threshold, the wireless device 202 then goes to an active state and runs a PSIST test. If the PSIST test passes, the wireless device 202 transmits the data.

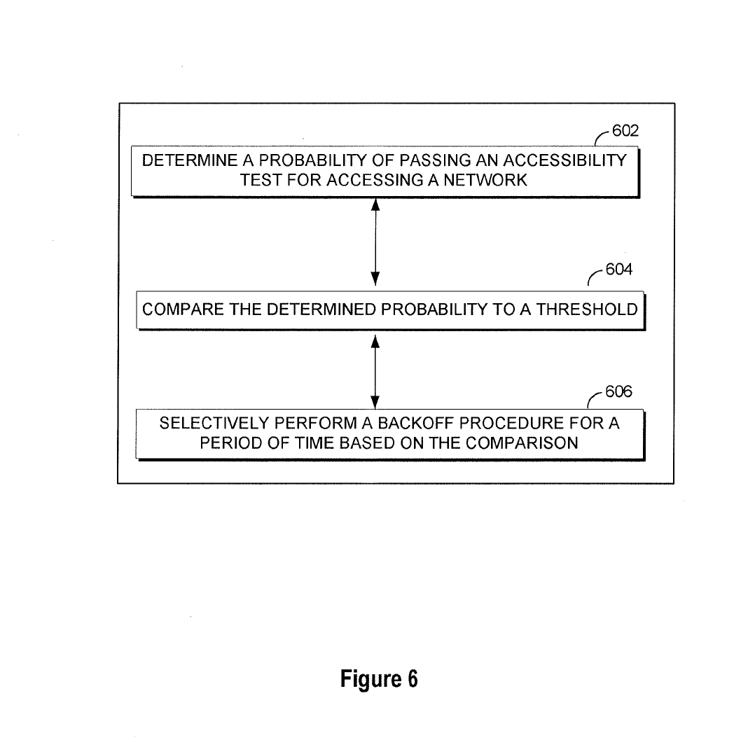

FIG. 6 is a flow chart of an exemplary method 600 for wireless communication. In certain embodiments, the method 600 can be performed by a wireless device 202, such as but not limited to a processor 204, DSP 220, and a transmitter 210 of a wireless device 202. Although the method 600 in FIG. 6 is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to process and transmit a generated message.

At operation block 602, a wireless device 202 may determine a probability of passing an accessibility test for accessing a network. At block 604, the wireless device 202 may compare the determined probability to a threshold. At block 606, the wireless device 202 may selectively perform a backoff procedure for a period of time based on the comparison.

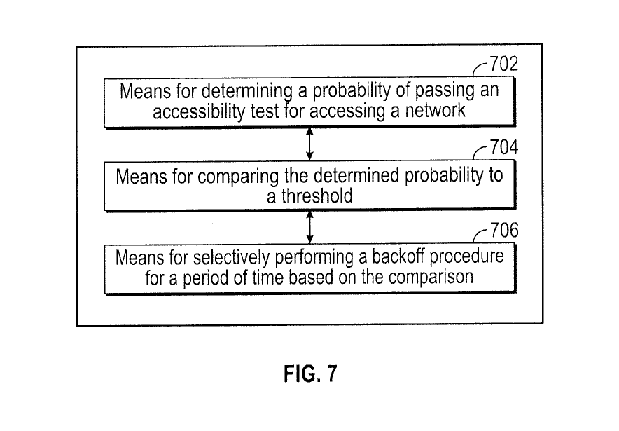

FIG. 7 is a functional block diagram of a wireless device that can be employed to perform the method of FIG. 6 in the wireless communication system of FIG. 1. Those skilled in the art will appreciate that the apparatus 700 may have more components than the simplified block diagrams shown in FIG. 7. FIG. 7 includes only those components useful for describing some prominent features of implementations within the scope of the claims.

The wireless device 700 can include a means 702 for determining a probability of passing an accessibility test for accessing a network. In certain embodiments, the means 702 for determining a message can be configured to perform one or more of the functions with respect to block 602 (FIG. 6). In various embodiments, the means 602 for determining a periodicity can be implemented by a processor 204 or DSP 220 (FIG. 2). The wireless device 700 further includes means 704 for comparing the determined probability to a threshold. In certain embodiments, the means 704 for comparing can be configured to perform one or more of the functions described above with respect to block 604 (FIG. 6). In various embodiments, the means 704 for comparing can be implemented by the processor 204 or DSP 220 (FIG. 2). The wireless device 700 further includes means 706 for selectively performing a backoff procedure for a period of time based on the comparison. In certain embodiments, the means 706 for selectively performing can be configured to perform one or more of the functions described above with respect to block 606 (FIG. 6). In various embodiments, the means 706 for selectively performing can be implemented by the processor 204 or DSP 220 (FIG. 2).

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In some aspects, wireless signals may be transmitted utilizing various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method for wireless communication, comprising:
determining a probability of passing an accessibility test for accessing a network;
comparing the determined probability to a threshold; and
selectively performing a backoff procedure for a period of time based on the comparison.

2. The method of claim 1, wherein the accessibility test comprises a persistence test.

3. The method of claim 1, further comprising selectively performing the accessibility test based on the comparison.

4. The method of claim 3, wherein selectively performing the accessibility test comprises performing the accessibility test when the determined probability satisfies the threshold.

5. The method of claim 1, wherein selectively performing a backoff procedure comprises performing the backoff procedure when the determined probability is less than the threshold.

6. The method of claim 1, wherein selectively performing a backoff procedure further comprises performing the backoff procedure based on a number of previous backoff procedures performed or an expiration of a timer.

7. The method of claim 6, wherein a maximum number of previous backoff procedures performed or a maximum length of the timer is based on a radio access technology carrier.

8. The method of claim 6, further comprising selectively performing the accessibility test based on the number of previous backoff procedures performed or the expiration of the timer.

9. The method of claim 8, wherein selectively performing the accessibility test comprises performing the accessibility test when the number of previous backoff procedures performed has reached a maximum value or upon the expiration of the timer.

10. The method of claim 1, further comprising:
decoding a message from the network; and
determining a change in the determined probability based on the message.

11. The method of claim 10, wherein decoding a message comprises determining a network persistence value or a network configuration value.

12. The method of claim 1, wherein the threshold is based on a level of power in a wireless device or a priority level.

13. The method of claim 1, wherein the network comprises a Global System for Mobile communications (GSM), a C2k, or a Wideband Code Division Multiple Access (WCDMA) network.

14. An apparatus for wireless communication, comprising:
a processor configured to:
determine a probability of passing an accessibility test for accessing a network;
compare the determined probability to a threshold; and
selectively perform a backoff procedure for a period of time based on the comparison.

15. The apparatus of claim 13, wherein the processor is further configured to selectively perform the accessibility test based on the comparison.

16. The apparatus of claim 15, wherein the processor is further configured to selectively perform the accessibility test when the determined probability satisfies the threshold.

17. The apparatus of claim 13, wherein the processor is further configured to perform the backoff procedure when the determined probability is less than the threshold.

18. The apparatus of claim 13, wherein the processor is further configured to perform the backoff procedure based on a number of previous backoff procedures performed or an expiration of a timer.

19. The apparatus of claim 18, wherein the processor is further configured to perform the accessibility test based on the number of previous backoff procedures performed or the expiration of the timer.

20. The apparatus of claim 18, wherein the processor is further configured to perform the accessibility test when the number of previous backoff procedures performed has reached a maximum value or upon the expiration of the timer.

21. The apparatus of claim 13, wherein the processor is further configured to:
decode a message from the network; and
determine a change in the determined probability based on the message.

22. The apparatus of claim 21, wherein the processor is further configured to determine a network persistence value or a network configuration value from the message.

23. The apparatus of claim 22, wherein the processor is further configured to determine the probability of passing the accessibility test based on the network persistence value or the network configuration value

24. An apparatus for wireless communication, comprising:
means for determining a probability of passing an accessibility test for accessing a network;
means for comparing the determined probability to a threshold; and
means for selectively performing a backoff procedure for a period of time based on the comparison.

25. The apparatus of claim 24, further comprising means for selectively performing the accessibility test based on the comparison.

26. The apparatus of claim 25, wherein the means for selectively performing the accessibility test comprises means for performing the accessibility test when the determined probability satisfies the threshold.

27. The apparatus of claim 24, further comprising:
means for decoding a message from the network; and
means for determining a change in the determined probability based on the message.

28. A non-transitory computer-readable medium comprising code that, when executed, causes a processor to:
determine a probability of passing an accessibility test for accessing a network;
compare the determined probability to a threshold; and
selectively perform a backoff procedure for a period of time based on the comparison.

29. The medium of claim 28, further comprising code that, when executed, causes a processor to selectively perform the accessibility test based on the comparison.

30. The medium of claim 28, further comprising code that, when executed, causes a processor to:
decode a message from the network; and
determine a change in the determined probability based on the message.
